(19) United States
(12) Patent Application Publication
(10) Pub. No.: US 2025/0133396 A1
(43) Pub. Date: Apr. 24, 2025

(54) ACCESS POINT (AP) AND METHOD TO ACHIEVE SECURITY OF COORDINATED BEAMFORMING

(71) Applicant: MEDIATEK INC., Hsinchu City (TW)

(72) Inventors: Chien-Fang HSU, Hsinchu City (TW); Hao-Hua KANG, Hsinchu City (TW); Chih-Chun KUO, Hsinchu City (TW)

(21) Appl. No.: 18/917,396

(22) Filed: Oct. 16, 2024

Related U.S. Application Data
(60) Provisional application No. 63/591,789, filed on Oct. 20, 2023.
(60) Provisional application No. 63/660,597, filed on Jun. 17, 2024.

(51) Int. Cl. H04W 12/04

(52) U.S. Cl. CPC H04W 12/04

(57) ABSTRACT

A first access point (AP) in a multiple access points (MAP) system of a wireless network is provided. The MAP system further includes a second AP. The first AP includes a transceiver and a control circuit. The transceiver transmits and receives frames over the wireless network. The control circuit transmits a protected frame to a non-AP station associated to the second AP, and receives a response frame in response to the protected frame from the non-AP station.

### CROSS REFERENCE TO RELATED APPLICATIONS

This application claims the benefit of U.S. Provisional Application No. 63/591,789, filed on Oct. 20, 2023, and U.S. Provisional Application No. 63/660,597, filed on Jun. 17, 2024, the entirety of which are incorporated by reference herein.

### BACKGROUND OF THE INVENTION

### Field of the Invention

The present invention relates to an electronic device, and, in particular, it relates to an access point (AP) and a method to achieve security of coordinated beamforming.

### Description of the Related Art

In a system with multiple access points (MAP) of a wireless network, multiple APs can coordinate transmissions to mitigate interference. Examples of this include coordinated beamforming (CBF) to increase the system throughput. An example of the latter is known as coordinated spatial reuse (CSR).

In some coordination scenarios, an AP needs to do frame exchange with clients (non-AP stations) of another basic service set (BSS) in the same MAP system. For example, in CBF, an AP may need to do sounding to collect the channel state information (CSI) of clients of the coordinated AP so that, during the CBF transmission, proper channel nulling can be done to mitigate the interference

However, when a protected frame is protected as a protected frame, with extra protection like a message integrity code (MIC), which requires a security key and a packet number (PN) to decrypt and to check the replay, how to do sounding with clients of another BSS needs to be addressed.

### BRIEF SUMMARY OF THE INVENTION

An embodiment of the present invention provides a first access point (AP) in a multiple access points (MAP) system of a wireless network. The MAP system further includes a second AP. The first AP include a transceiver and a control circuit. The transceiver transmits and receives frames over the wireless network. The control circuit transmits a protected frame to a non-AP station associated to the second AP, and receives a response frame in response to the protected frame from the non-AP station.

According to the first AP described above, the protected frame is encrypted by a unified security key distributed over the MAP system or by a shared security key derived from the second AP through a backhaul or a fronthaul connecting the first AP and the second AP.

According to the first AP described above, the protected frame is encrypted by a non-shared security key of the first AP.

According to the first AP described above, the control circuit further transmits an announcement frame to the second AP before transmitting the protected frame. The announcement frame includes a plurality of security parameters to encrypt the protected frame.

According to the first AP described above, the plurality of security parameters include an indicator of the security key.

According to the first AP described above, the plurality of security parameters further include a packet number (PN) associated to the security key.

An embodiment of the present invention also provides a non-AP station associated to a first AP in a multiple access point (MAP) system of a wireless network. The MAP system further includes a second AP. The non-AP station includes a transceiver and a control circuit. The transceiver transmits and receives frames over the wireless network. The control circuit receives a protected frame from the second AP, and transmits a response frame in response to the protected frame to the second AP.

According to the non-AP station described above, the protected frame is decrypted by a unified security key distributed over the MAP system or by a shared security key distributed from the first AP to the second AP through a backhaul or a fronthaul connecting the first AP and the second AP.

According to the non-AP station described above the protected frame is decrypted by a non-shared security key of the second AP.

According to the non-AP station described above, the non-AP station derives the unified security key or the shared security key through a first management frame transmitted from the first AP during an association to the first AP.

According to the non-AP station described above, the first management frame is a beacon frame, or a probe response frame, or a (re)association response frame.

According to the non-AP station described above, the non-AP station derives an update of either the unified security key or the shared security key through a second management frame transmitted from the first AP after an association to the first AP.

According to the non-AP station described above, the non-AP station derives the non-shared key through a management frame transmitted from the first AP.

According to the non-AP station described above, the non-AP station derives the non-shared key through a management frame transmitted from the second AP.

According to the non-AP station described above, the non-shared security key is distributed from the second AP to the first AP through a backhaul or a fronthaul connecting the first AP and the second AP.

According to the non-AP station described above, the non-AP station identifies a security key to decrypt the protected frame by an identifier carried in the protected frame.

According to the non-AP station described above, the non-AP station maintains a PN space identified by the identifier and the security key.

According to the non-AP station described above, the identifier is a transmitter address (TA) or a BSSID.

An embodiment of the present invention also provides a method to achieve security of coordinated beamforming in a MAP system of a wireless network. The method is applicable to a first AP. The MAP system includes a first AP and a second AP. The method includes the following steps. The first AP transmits a protected frame to a non-AP station associated to the second AP, and receives a response frame in response to the protected frame from the non-AP station.

An embodiment of the present invention also provides a method to achieve security of coordinated beamforming in a MAP system of a wireless network. The MAP system includes a first AP and a second AP. The method is applicable to a non-AP station associated to a first AP in the MAP system of the wireless network. The MAP system further includes a second AP. The method includes the following steps. The non-AP station receives a protected frame from the second AP, and transmits a response frame in response to the protected frame to the second AP.

### BRIEF DESCRIPTION OF THE DRAWINGS

The present invention can be more fully understood by reading the subsequent detailed description and examples with references made to the accompanying drawings, wherein:

FIG. 1 shows a schematic diagram of a multiple access points (MAP) system 100 in accordance with some embodiments of the present invention;

FIG. 2 shows a schematic diagram of a data transmission sequence in the MAP system 100 in FIG. 1 in accordance with some embodiments of the present invention;

FIG. 3 shows a schematic diagram of a data transmission sequence in the MAP system 100 in FIG. 1 in accordance with some embodiments of the present invention;

FIG. 4 shows a schematic diagram of a data transmission sequence in the MAP system 100 in FIG. 1 in accordance with some embodiments of the present invention;

FIG. 5 shows a schematic diagram of a data transmission sequence in the MAP system 100 in FIG. 1 in accordance with some embodiments of the present invention;

FIG. 6 shows a schematic diagram of a data transmission sequence in the MAP system 100 in FIG. 1 in accordance with some embodiments of the present invention;

FIG. 7 shows a flow chart of a method to achieve security of coordinated beamforming in the MAP system 100 applied to a first AP AP1 in FIG. 1 in accordance with some embodiments of the present invention; and

FIG. 8 shows a flow chart of a method to achieve security of coordinated beamforming in the MAP system 100 applied to a second non-AP station STA2 in FIG. 1 in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up” “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, and “third” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

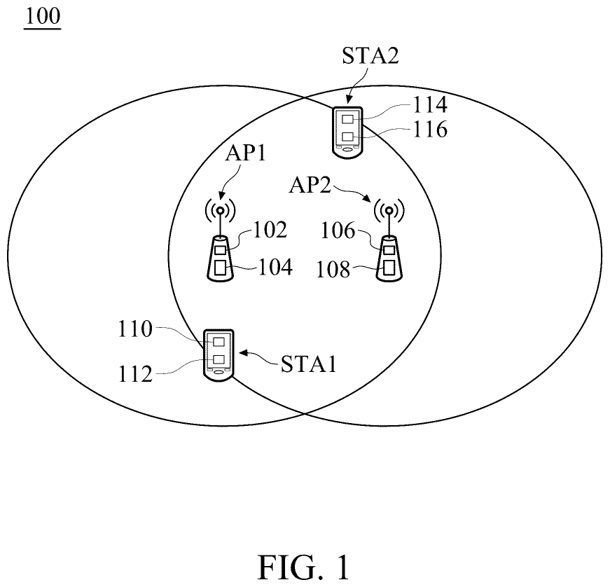

FIG. 1 shows a schematic diagram of a multiple access points (MAP) system 100 in accordance with some embodiments of the present invention. As shown in FIG. 1, the MAP system 100 includes a first access point (AP) AP1, a second AP AP2, a first non-AP station STA1, and a second non-AP station STA2. The first AP AP1 has a first basic service set (BSS) with the first non-AP station STA1, and the second AP AP2 has a second BSS with the second non-AP station STA2. In some embodiments, the first AP AP1 includes a transceiver 102 and a control circuit 104. The control circuit 104 is electrically coupled to the control circuit 102. The second AP AP2 includes a transceiver 106 and a control circuit 108. The control circuit 108 is electrically coupled to the transceiver 106. In some embodiments, the transceivers 102 and 106 transmit and receive frames over a wireless network. The control circuit 104 transmits a protected frame to the second non-AP station STA2 associated to the second AP AP2. The control circuit 104 receives a response frame in response to the protected frame from the second non-AP station STA2. In some embodiments, the protected frame may be a beamforming report poll (BFRP) frame, a control frame or a trigger frame, but the present invention is not limited thereto. In detail, the control circuit 104 of the first AP AP1 sends an announcement frame to the second AP AP2 before transmitting the protected frame. The announcement frame includes a plurality of security parameters to encrypt the protected frame. In some embodiments, the plurality of security parameters include an indicator of a security key. The plurality of security parameters further include a packet number (PN) associated to the security key.

In some embodiments, the protected frame is encrypted by a unified security key distributed over the MAP system 100 or by a shared security key derived from the second AP AP2 through a backhaul or a fronthaul connecting the first AP AP1 and the second AP AP2. In some embodiments, the protected frame is encrypted by a non-shared security key of the first AP AP1.

Next, the control circuit 104 of the first AP AP1 starts the sounding sequence to send a protected frame to the first non-AP station STA1 and the second non-AP station STA2 after receiving a response frame from the second AP AP2. The control circuit 104 of the first AP AP1 receives channel state information (CSI) of the first station STA1 and the second station STA2 for coordinated beamforming (CBF). In some embodiments, when the security key is the unified key, the unified key is a group key distributed in the MAP system 100 for such sharing scenario. The PN included in the announcement frame is derived from a common multi-link device (CMLD) by the first AP AP1 before the announcement frame is transmitted. The CMLD, such as a virtual host taking care of information distribution among APs or AP MLDs, or a master AP or a master AP MLD in charge of the update of the group key. When a client, such as a non-AP station not belong to the same BSS with the first AP AP1, connects or associates with the MAP system 100, the unified key is sent in a probe response frame or in a (re)association response frame.

When the security key is the unified key, the first AP AP1 may update the unified key in a beacon fame for its associated client, that is, the first non-AP station STA1. The second AP AP2 may update the unified key in the beacon frame for its associated client, that is, the second non-AP station STA2. When the security key is the unified key, the first AP AP1 and the second AP AP2 use the same key to encrypt the protected frame. In some embodiments, the protected frame may be a beamforming report poll (BFRP) frame.

When the security key is the shared key, the first AP AP1 may share the shared key to encrypt the protected frame, including the BFRP, with the second AP AP2. Depending on the target client of the BFRP, the first AP AP1 uses different keys for encryption. For example, it is assured that the target client is the second non-AP station STA2. When the target client is associated to the first BSS, the first AP AP1 uses its own key to encrypt the protected frame. When the target client is not associated to the first BSS, the first AP AP1 uses the key of the second AP AP2 (that is, the key of the second BSS) to encrypt the protected frame. In some embodiments, when multiple clients exist, for MU (MIMO or OFDMA) case, and the multiple clients are associated to different BSSs, the first AP AP1 uses its own key to encrypt the protected frame, or uses the key of the other BSS to encrypt the protected frame. In some embodiments, key selection can be based on BSS of the target client's resource unit (RU) in a physical layer protocol data unit (PPDU) or of the target client's resource address (RA) in the protected frame. That is, different RUs or frames may be encrypted by different keys. In some embodiments, an extra indicator or a negotiation for the key selection is acquired in advance to specify the key to be used.

When the security key is the non-shared key, the first AP AP1 may always use its own key to encrypt the protected frame. When the protected frame as a BFRP is targeted to a client of other BSS, the client of other BSS needs to know the key. The client needs to maintain multiple keys with more complexity. In some embodiments, the non-shared key is indicated through transmitter address (TA) or other AP ID, such as BSSID, in the BFRP.

In some embodiments of FIG. 1, the first non-AP station STA1 includes a transceiver 110 and a control circuit 112. The second non-AP station STA2 includes a transceiver 114 and a control circuit 116. Taking the second non-AP station STA2 as an example, the transceiver 114 transmits and receives frames over the wireless network. The control circuit 116 receives the protected frame from the second AP AP2, and transmits the response frame in response to the protected frame to the second AP AP2. In some embodiments, the protected frame is decrypted by a unified security key distributed over the MAP system 100 or by a shared security key distributed from the first AP AP1 to the second AP AP2 through a backhaul or a fronthaul connecting the first AP AP1 and the second AP AP2. In some embodiments, the second non-AP station STA2 derives the unified security key or the shared security key through a first management frame transmitted from the first AP AP1 during an association to the first AP AP1. The first management frame is a beacon frame, or a probe response frame, or a (re)association response frame. In some embodiments, the second non-AP station STA2 derives an update of either the unified security key or the shared security key through a second management frame transmitted from the first AP AP1 after an association to the first AP AP1.

In some embodiments, the protected frame is decrypted by a non-shared security key of the second AP AP2. The second non-AP station STA2 derives the non-shared key through a management frame transmitted from the first AP AP1. The non-shared security key is distributed from the second AP AP2 to the first AP AP1 through a backhaul or a fronthaul connecting the first AP AP1 and the second AP AP2.

In some embodiments, the non-AP station identifies a security key to decrypt the protected frame by an identifier carried in the protected frame. The second non-AP station STA2 maintains a PN space identified by the identifier and the security key. The identifier is a transmitter address (TA) or a BSSID.

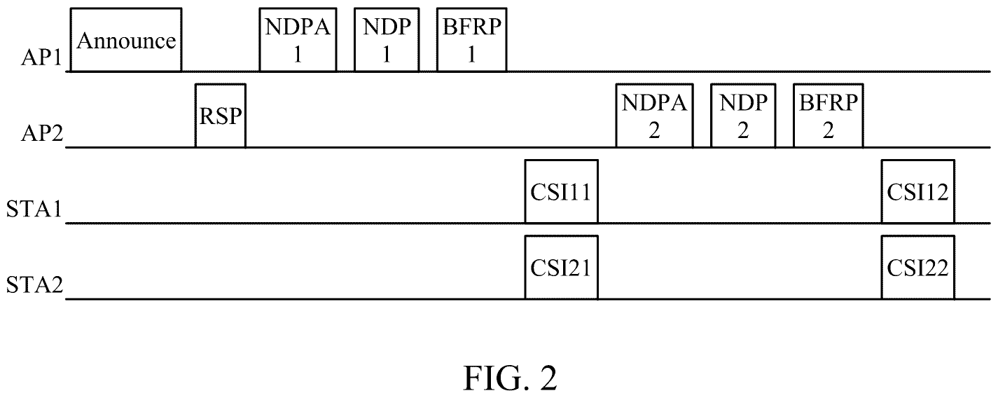

FIG. 2 shows a schematic diagram of a data transmission sequence in the MAP system 100 in FIG. 1 in accordance with some embodiments of the present invention. In some embodiments of FIG. 2, the security key includes the unified key or the shared key. As shown in FIG. 2, the first AP AP1 sends an announcement frame (marked as Announce) to the second AP AP2. The announcement frame includes information of a security key and an optional PN for a sounding sequence. After receiving the announcement frame from the first AP AP1, the second AP AP2 sends a response frame RSP back to the first AP AP1. The first AP AP1 starts the sounding sequence to send a null data packet announcement (NDPA) using a frame NDPA1, a null data packet (NDP) using a frame NDP1, and a protected frame BFRP1 in sequence to the first non-AP station STA1 and the second non-AP station STA2 after receiving a response frame RSP from the second AP AP2. In detail, the first AP AP1 sends the NDPA using the frame NDPA1, the NDP using the frame NDP1, and the protected frame BFRP1 to the first non-AP station STA1 of the first BSS during the sounding sequence. The first AP AP1 sends the NDPA using the frame NDP1, the NDP using the frame NDP1, and the protected frame BFRP1 to the second non-AP station STA2 of the second BSS during the sounding sequence. The sounding sequence of the first AP AP1 may include the transmission of the frames NDPA1 and NDP1, and the protected frame BFRP1. The PPDU carries NDP1 is a multiple spatial stream PPDU with spatial stream NSS1. The PPDU carries NDP2 is a multiple spatial stream PPDU with spatial stream NSS2. First AP AP1 and second AP AP2 are capable of transmitting PPDUs with multiple spatial streams are equipped with multiple antennas.

After that, the first non-AP station STA1 sends its CSI using a frame CSI11 to the first AP AP1 and the second non-AP station STA2 sends its CSI using a frame CSI21 to the first AP AP1 simultaneously in response to receiving the protected frame BFRP1 from the first AP APL. After the first AP AP1 receives the CSI from the first non-AP station STA1 and the second non-AP station STA2, the second AP AP2 starts the sounding sequence to send the NDPA using a frame NDPA2, the NDP using a frame NDP2, and a protected frame BFRP2 in sequence to the first non-AP station STA1 and the second non-AP station STA2. In detail, the second AP AP2 sends the NDPA using the frame NDPA2, the NDP using the frame NDP2, and the protected frame BFRP2 to the second non-AP station STA2 through the second BSS during the sounding sequence. The second AP AP2 sends the NDPA using the frame NDPA2, the NDP using the frame NDP2, and the protected frame BFRP2 to the first non-AP station STA1 through the first AP AP1 and the first BSS during the sounding sequence. The sounding sequence of the second AP AP2 may include the transmission of the frames NDPA2 and NDP2, and the protected frame BFRP2. In some embodiments of FIG. 2, there is no frame exchange sequence (FES) between the frames CSI11, CSI21 and the frame NDPA2.

In some embodiments of FIG. 2, the announcement frame does not include the information of the security key when no rekeying happens in the unified key or the shared key. When the security key is the unified key, the PN included in the announcement frame is derived from the CMLD by the first AP AP1 before the announcement frame is transmitted. When the security key is the shared key, the PN included in the announcement frame is determined by the first AP AP1. When the security key is the shared key, the protected frame BFRP1 further includes an extra indicator to indicate which shared key is used. The shared key may be from other BSS or other AP in the MAP system, or may be the internal key for the protected frame BFRP1, or the internal key for the protected frame BFRP2.

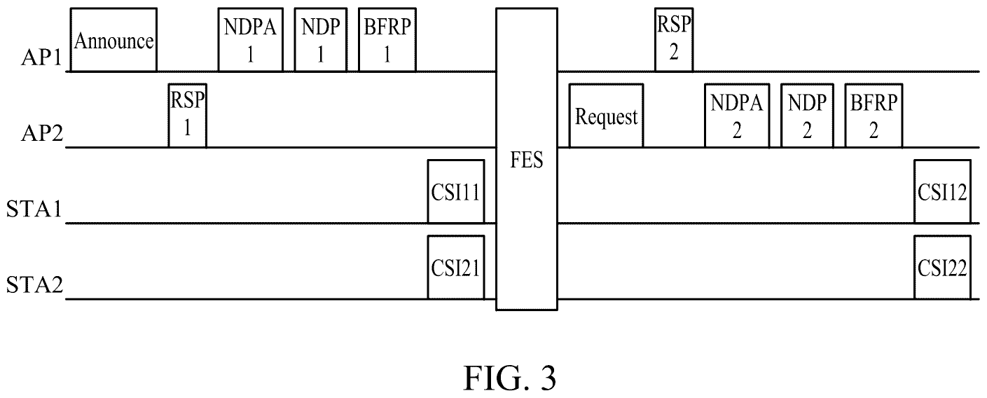

FIG. 3 shows a schematic diagram of a data transmission sequence in the MAP system 100 in FIG. 1 in accordance with some embodiments of the present invention. As shown in FIG. 3, the main difference between FIG. 3 and FIG. 2 is that, in FIG. 3, a frame exchange sequence (marked as FES) is present after the first station STA1 sends its CSI using the frame CSI11 to the first AP AP1 and the second non-AP station STA2 sends its CSI to the first AP using the frame CSI21 simultaneously. After the first non-AP station STA1 sends its CSI using the frame CSI11 to the first AP AP1 and the second non-AP station STA2 sends its CSI to the first AP using the frame CSI21 simultaneously, the second AP AP2 sends a request (marked as Request) frame to the first AP AP1 for an updated PN. The first AP AP1 sends a response frame RSP2 to the second AP AP2 in response to receiving the request from the second AP AP2. The second AP AP2 then starts the sounding sequence in response to receiving the response RSP2 including the updated PN from the first AP AP1. In some embodiments of FIG. 3, after receiving the announcement frame from the first AP AP1, the second AP AP2 sends a response RSP1 to the first AP AP1, so that the first AP AP1 starts the sounding sequence in response to receiving the response RSP1 from the second AP AP2.

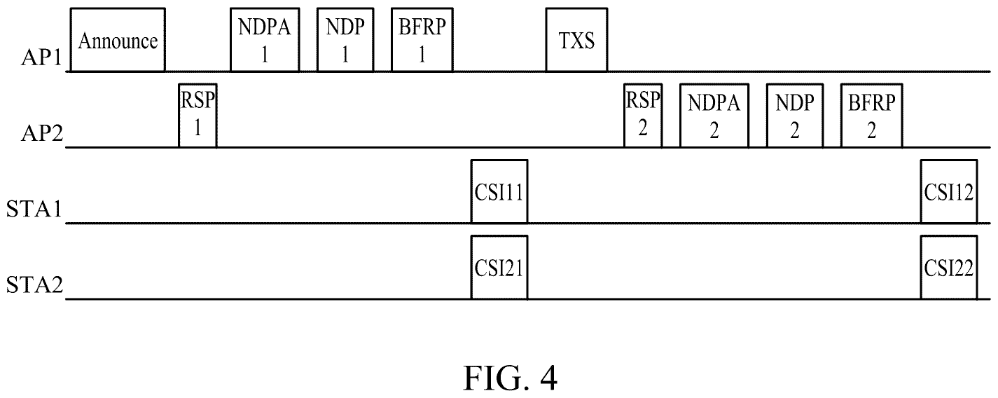

FIG. 4 shows a schematic diagram of a data transmission sequence in the MAP system 100 in FIG. 1 in accordance with some embodiments of the present invention. As shown in FIG. 4, the main difference between FIG. 4 and FIG. 2 is that, in FIG. 4, after the first non-AP station STA1 sends its CSI using the frame CSI11 to the first AP AP1 and the second non-AP station STA2 sends its CSI to the first AP using the frame CSI21 simultaneously, the first AP AP1 shares a transmit opportunity (TXOP) to the second AP using a TOXP sharing (TXS) frame TXS. The TXOP enables the second AP AP2 to use the TXOP that is originally acquired by the first AP AP1. The second AP AP2 starts the sounding sequence in response to sending a response frame RSP2 to the first AP AP1. In some embodiments of FIG. 4, after receiving the announcement frame from the first AP AP1, the second AP AP2 sends a response frame RSP1 to the first AP AP1, so that the first AP AP1 starts the sounding sequence in response to receiving the response frame RSP1 from the second AP AP2.

In some embodiments of FIGS. 2-4, when the security key is the unified key, a host, for example, a virtual CMLD or a master AP MLD or a master AP, is in charge of generation or update of the security key and maintenance of the PN. The first AP AP1 or the second AP AP2 within the MAP system 100 gets the security key from the CMLD. When the security key is the unified key, the first non-AP station STA1 or the second non-AP station STA2 gets the security key from an (re)association response frame or a probe response during an association, or the first non-AP station STA1 or the second non-AP station STA2 gets the security key from a beacon frame or a management frame after the association if a security key update happens. The first non-AP station STA1 and the second non-AP station STA2 only needs to maintain one extra key only.

In some embodiments of FIGS. 2-4, when the security key is the shared key or the non-shared key, the first AP AP1 and the second AP AP2 generate their own security keys, and update their own security keys to each other through beacon frames or a backhaul or a fronthaul to perform CBF. When the security key is the shared key or the non-shared key, the first non-AP station STA1 or the second non-AP station STA2 gets the security key in a beacon frame or a management frame which contains required security keys of other BSSs to perform CBF. The security key in the beacon frame may be identified by an BSSID. The first non-AP station STA1 or the second non-AP station STA2 identifies the security key to be used by a transmitter address (TA) or a BSSID of the protected frame RFRP1 or RFRP2. When the security key is the shared key or the non-shared key, how many keys the first non-AP station STA1 or the second non-AP station STA2 needs to maintain corresponds to the complexity.

Table 1 shows an example of the message design of the unified key.

TABLE 1

| | | Element ID | | | |
|---|---|---|---|---|---|
| Element ID | Length | Extension | KEY ID | Key | PN |
| 1 | 1 | 1 | 1 | 64 | 8 |

The data sizes in Table 1 are shown in octet, but the present invention is not limited thereto. In some embodiments, the key length depends on the security protocol to be used for protection. The key can be optional when no re-key happens.

Table 2 shows an example of the message design of the shared key.

TABLE 2

| | | Element | | | | | | |
|---|---|---|---|---|---|---|---|---|
| Element | | ID | | | | | | |
| ID | Length | Extension | BBSID1 | Key | PN | BBSID2 | Key | PN |
| 1 | 1 | 1 | 1 | 64 | 8 | 1 | 64 | 8 |

The data sizes in Table 2 are shown in octet, but the present invention is not limited thereto. As shown in Table 2, multiple keys (for example, two keys) can be shared. BSSID can be replaced by another identifier, such as AP MLD ID or mixed multiple identifier, for example, cascaded of BSSID plus AP MLD ID.

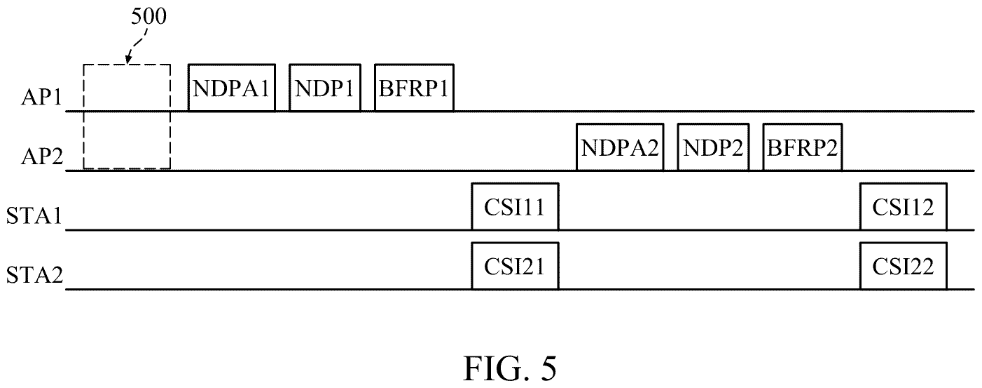

FIG. 5 shows a schematic diagram of a data transmission sequence in the MAP system 100 in FIG. 1 in accordance with some embodiments of the present invention. In some embodiments of FIG. 5, the first AP AP1 (for example, the control circuit 104 of the first AP AP1) sends information of a security key and an optional PN for a sounding sequence to the second AP AP2 through backhaul 500, so that the second AP AP2 knows the security key and the PN for the sounding sequence. Then, the first AP AP1 starts the sounding sequence to send the NDPA using the frame NDPA1, the NDP using the frame NDP1, and the protected frame BFRP1 to the first non-AP station STA1 and the second non-AP station STA2. The first non-AP station STA1 sends its CSI using the frame CSI11 to the first AP AP1 in response to receiving the protected frame BFRP1. The second non-AP station STA2 sends its CSI using the frame CSI21 to the first AP AP1 in response to receiving the protected frame BFRP1.

After the first AP AP1 receives the CSI from the first non-AP station STA1 and the second non-AP station STA2, the second AP AP2 starts the sounding sequence to send the NDPA using the frame NDPA2, the NDP using the frame NDP2, and the protected frame BFRP2 in sequence to the first non-AP station STA1 and the second non-AP station STA2. The first non-AP station STA1 sends its CSI using the frame CSI12 to the second AP AP2 in response to receiving the protected frame BFRP2. The second station STA2 sends its CSI using the frame CSI22 to the second AP AP2 in response to receiving the protected frame BFRP2. In some embodiments of FIG. 5, the security key may include the unified key or the shared key. The first AP AP1 updates the PN (when incremented) and the security key (when re-key happens) through backhaul 500 to the second AP AP2. The update needs to be in time before the frame BFRP2 is transmitted. In some embodiments of FIG. 5, there is no frame exchange sequence (FES) between the frames CSI11, CSI21 and the frame NDPA2.

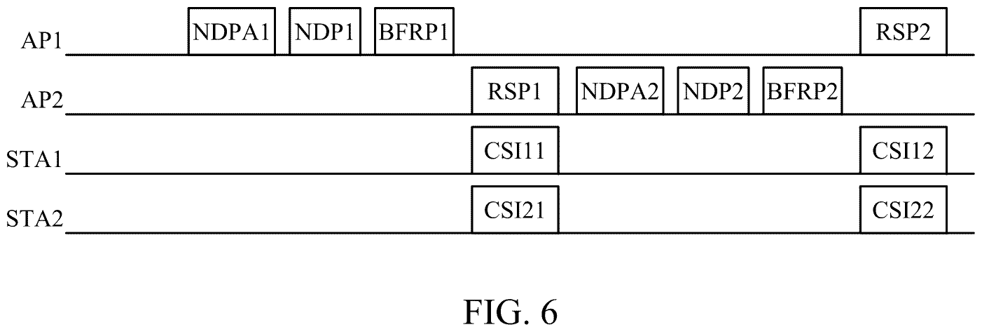

FIG. 6 shows a schematic diagram of a data transmission sequence in the MAP system 100 in FIG. 1 in accordance with some embodiments of the present invention. In some embodiments of FIG. 6, the security key may include the unified key or the shared key. As shown in FIG. 6, the main difference between FIG. 6 and FIG. 5 is that, in FIG. 6, the first AP AP1 sends the protected frame BFRP1 including the security key and the optional PN for the sounding sequence to the second AP AP2. It is assumed that the second AP AP2 can receive or decode or decrypt the protected frame BFRP1 with the security key. The second AP AP2 sends a response frame RSP1 to the first AP AP1 in response to receiving the protected frame BFRP1 from the first AP AP1. The second AP AP2 decodes and decrypts the protected frame BFRP1 from the first AP AP1 to obtain the security key and the optional PN for the sounding sequence.

In some embodiments, similarly, the second AP AP2 sends the protected frame BFRP2 including the security key and the optional PN for the sounding sequence to the first AP AP1. The first AP AP1 sends a response frame RSP2 to the second AP AP2 in response to receiving the protected frame BFRP2 from the second AP AP2. The first AP AP1 decodes and decrypts the protected frame BFRP2 from the second AP AP2 to obtain the security key and the PN for the sounding sequence. In some embodiments of FIG. 6, there may be the frame exchange sequence FES in FIG. 3 or the frame TXS in FIG. 4 between the frames CSI11, CSI21 and the frame NDPA2.

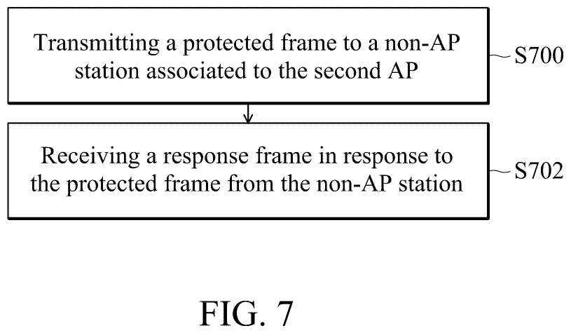

FIG. 7 shows a flow chart of a method to achieve security of coordinated beamforming in the MAP system 100 applied to a first AP AP1 in FIG. 1 in accordance with some embodiments of the present invention. The MAP system includes a first AP (for example, the first AP AP1 in FIG. 1), a second AP (for example, the second AP AP2 in FIG. 1), a first non-AP station (for example, the first station STA1 in FIG. 1), and a second non-AP station (for example, the second station STA2 in FIG. 1). The first AP has a first basic service set (BSS) with the first non-AP station, and the second AP has a second BSS with the second non-AP station. The method to achieve security of coordinated beamforming of the present invention includes the following steps. The first AP transmits a protected frame to a second non-AP station associated to the second AP (step S700). The first AP receives a response frame in response to the protected frame from the second non-AP station (step S702).

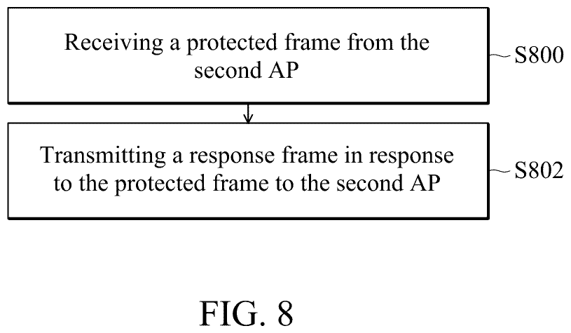

FIG. 8 shows a flow chart of a method to achieve security of coordinated beamforming in the MAP system 100 applied to a second non-AP station STA2 in FIG. 1 in accordance with some embodiments of the present invention. The MAP system includes a first AP (for example, the first AP AP1 in FIG. 1), a second AP (for example, the second AP AP2 in FIG. 1), a first non-AP station (for example, the first station STA1 in FIG. 1), and a second non-AP station (for example, the second station STA2 in FIG. 1). The first AP has a first basic service set (BSS) with the first non-AP station, and the second AP has a second BSS with the second non-AP station. The method to achieve security of coordinated beamforming of the present invention includes the following steps. The second non-AP station receives a protected frame from the second AP (step S800). The second non-AP station transmits a response frame in response to the protected frame to the second AP. (step S802).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A first access point (AP) in a multiple access point (MAP) system of a wireless network, wherein the MAP system further comprises a second AP, comprising:
a transceiver, configured to transmit and receive frames over the wireless network, and
a control circuit configured to:
transmit a protected frame to a non-AP station associated to the second AP; and
receive a response frame in response to the protected frame from the non-AP station.

2. The first AP as claimed in claim 1, wherein the protected frame is encrypted by a unified security key distributed over the MAP system or by a shared security key derived from the second AP through a backhaul or a fronthaul connecting the first AP and the second AP.

3. The first AP as claimed in claim 1, wherein the protected frame is encrypted by a non-shared security key of the first AP.

4. The first AP as claimed in claim 2, wherein the control circuit is further configured to transmit an announcement frame to the second AP before transmitting the protected frame, wherein the announcement frame comprises a plurality of security parameters to encrypt the protected frame.

5. The first AP as claimed in claim 4, wherein the plurality of security parameters comprise an indicator of the security key.

6. The first AP as claimed in claim 5, wherein the plurality of security parameters further comprise a packet number (PN) associated to the security key.

7. A non-AP station associated to a first AP in a multiple access point (MAP) system of a wireless network, wherein the MAP system further comprises a second AP, comprising:
a transceiver, configured to transmit and receive frames over the wireless network, and
a control circuit, configured to:
receive a protected frame from the second AP; and
transmit a response frame in response to the protected frame to the second AP.

8. The non-AP station as claimed in claim 7, wherein the protected frame is decrypted by a unified security key distributed over the MAP system or by a shared security key distributed from the first AP to the second AP through a backhaul or a fronthaul connecting the first AP and the second AP.

9. The non-AP station as claimed in claim 7, wherein the protected frame is decrypted by a non-shared security key of the second AP.

10. The non-AP station as claimed in claim 8, wherein the non-AP station derives the unified security key or the shared security key through a first management frame transmitted from the first AP during an association to the first AP.

11. The non-AP station as claimed in claim 10, wherein the first management frame is a beacon frame, or a probe response frame, or a (re)association response frame.

12. The non-AP station as claimed in claim 8, wherein the non-AP station derives an update of either the unified security key or the shared security key through a second management frame transmitted from the first AP after an association to the first AP.

13. The non-AP station as claimed in claim 9, wherein the non-AP station derives the non-shared key through a management frame transmitted from the first AP.

14. The non-AP station as claimed in claim 9, wherein the non-AP station derives the non-shared key through a management frame transmitted from the second AP.

15. The non-AP station as claimed in claim 13, wherein the non-shared security key is distributed from the second AP to the first AP through a backhaul or a fronthaul connecting the first AP and the second AP.

16. The non-AP station as claimed in claim 7, wherein the non-AP station identifies a security key to decrypt the protected frame by an identifier carried in the protected frame.

17. The non-AP station as claimed in claim 16, wherein the non-AP station maintains a PN space identified by the identifier and the security key.

18. The non-AP station as claimed in claim 16, wherein the identifier is a transmitter address (TA) or a BSSID.

19. A method to achieve security of frame exchange in a MAP system of a wireless network, applicable to a first AP, wherein the MAP system comprises the first AP and a second AP, comprising:
transmitting a protected frame to a non-AP station associated to the second AP; and
receiving a response frame in response to the protected frame from the non-AP station.

20. A method to achieve security of frame exchange in a MAP system of a wireless network, applicable to a non-AP station associated to a first AP in the MAP system of a wireless network, wherein the MAP system further comprises a second AP, comprising:
receiving a protected frame from the second AP; and
transmitting a response frame in response to the protected frame to the second AP.
